(19) United States
(12) Patent Application Publication
(10) Pub. No.: US 2006/0178512 A1
(43) Pub. Date: Aug. 10, 2006

(54) Method for preparing amino acid esters of nucleoside analogues

(76) Inventors: Cheruthur Govindan, Murrysville, PA (US); Alain Burgos, Les Ponts de Ce' (FR); Huayun Yu, Monroeville, PA (US); Sarah L. Topper, Allison Park, PA (US)

Correspondence Address: Linda Pingitore;PPG Industries, Inc., One PPG Place, Pittsburgh, PA, 15272, US

(21) Appl. No.: 11/051,895

(22) Filed: Feb. 4, 2005

(51) Int. Cl. C07F 9/6512

(52) U.S. Cl. 544/243; 544/244

(57) ABSTRACT

Describes a process for preparing esters of nucleoside analogues comprising condensing a nucleoside analogue with a protected amino acid in the presence of a tertiary amine and in the presence of an activating amount of an activating agent chosen from organo phosphoryl halide, organo phosphinic halide, aliphatic sulfonyl halide, and aromatic sulfonyl halide.

### BACKGROUND OF THE INVENTION

Nucleoside analogues are an important class of drugs useful predominantly for their antiviral activity. Their major therapeutic effect stems from their ability to interfere with viral nucleic acid metabolism, e.g., DNA or RNA replication. Derivatives of nucleoside analogues have been developed in order to improve their properties, e.g., their bioavailability. For example, acyclovir [9-(2-hydroxyethoxymethyl) guanine], possesses high antiviral activity, particularly against the herpes viruses, but is poorly absorbed from the gastrointestinal tract after oral administration. Such low bioavailability requires the administration of large doses of acyclovir in order to achieve and maintain effective antiviral levels in the plasma of the person or animal being treated.

Certain amino acid esters of nucleoside analogues have been synthesized to improve the water solubility of the nucleoside analogue, and hence its bioavailability. For example, valine, isoleucine, glycine and alanine esters of acyclovir have been synthesized. Amino acid esters of nucleoside analogues have been synthesized through direct coupling (esterification) of a hydroxyl group on the nucleoside analogue and the carboxyl group of the amino acid. The foregoing direct esterification method commonly involves use of coupling reagents, such as dicyclohexyl carbodiimide (DCC). Use of DCC in the esterification process results in the formation of dicyclohexyl urea (DCU) as a by-product. Dicyclohexyl urea is a solid that is insoluble in many common solvents used in the preparation of amino acid esters of nucleoside analogues, and its separation from the amino acid ester and ultimate disposal is expensive. There is, therefore, a need for alternative methods for preparing amino acid esters of nucleoside analogues that avoids the use of DCC or other expensive carbodiimides.

### DESCRIPTION OF THE INVENTION

In accordance with a non-limiting embodiment of the present invention, there is described a process for preparing amino acid esters of nucleoside analogues that comprises coupling a nucleoside analogue with a protected amino acid in the presence of a tertiary amine and an activating agent chosen from organo phosphoryl halides, organo phosphinic halides, aliphatic sulfonyl halides and aromatic sulfonyl halides. In this process, a reactive hydroxyl group on the nucleoside analogue reacts with a carboxyl group of the protected amino acid under the coupling reaction condition parameters chosen.

For purposes of this specification (other than in the operating examples) or unless otherwise indicated, all numbers expressing quantities and ranges of ingredients, reaction conditions, etc, that are used in the following description and claims are to be understood as prefaced in all instances by the term “about”. Accordingly unless indicated to the contrary, the numerical parameters set forth in this description and attached claims are approximations that can vary depending upon the results that are sought to be obtained by the process of the present invention. At the very least, and not as an attempt to limit the application of the doctrine of equivalents to the scope of the attached claims, each numerical parameter should at least be construed in light of the number of reported significant digits and by applying ordinary rounding techniques. Further, as used in this specification and the attached claims, the singular forms “a”, “an” and “the” are intended to include plural referents, unless expressly and unequivocally limited to one referent. Moreover, plural referents are intended to encompass the singular form.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurement. Also, it should be understood that any numerical range recited herein is intended to include all sub-ranges subsumed therein. For example, a range of “1 to 10” is intended to include all sub-ranges between and including the recited minimum value of 1 and the recited maximum value of 10; namely, a range having a minimum value equal to or greater than 1 and a maximum value of equal to or less than 10. Because the disclosed ranges are continuous, they include every value between the minimum and maximum values. Unless expressly indicated otherwise, the various numerical ranges specified in this application are, as stated, approximations.

Hydrolysis of nucleic acids that includes removal of the phosphoric acid moiety yields compounds that are known in the art as nucleosides. Naturally occurring nucleosides have two components, a nitrogen-containing purine or pyrimidine ring structure linked to a pentose, e.g., a sugar molecule such as β-d-ribose or d-deoxyribose. Purines are guanine and adenine, while pyrimidines are cytosine and thymine. Such nucleosides form the building blocks of DNA and RNA and are thus recognized by and interact with DNA/RNA synthesizing enzymes, including the enzymes of infecting viruses. The sugar component of naturally occurring nucleosides can be altered or replaced to form an analogue that is still recognized by the viral machinery. For example, the sugar component of a naturally occurring nucleoside can be replaced by another hydroxyl-containing group, e.g., a hydroxyl-containing alkyl or alkoxyalkyl group, as in the compound known in the art as acyclovir, which is a synthetic purine nucleoside analogue derived from guanine. Acyclovir (CAS 59277-89-3) can be named [9-(2-hydroxyethoxy)methyl guanine]. Modification of the “sugar” component of the nucleoside can result in alteration of the chemical nature of that moiety such that it may no longer technically be referred to as a sugar. The term “nucleoside analogue”, as used in the following description and claims, is intended to cover also such analogues. Nucleoside analogues are described extensively in the literature and many are listed, for example, in Nasr et al, Antiviral Research, Volume 14, pp 125-148 (1990), or McGowan et al, Antiviral Chemotherapy, Volume 2, pp 333-345, (Mills and Corely, Editors, 1989).

As used in the following description and claims, the following terms have the indicated meanings:

The term “aliphatic” means pertaining to an open (acyclic) straight or branched chain hydrocarbon, e.g., an aliphatic hydrocarbon compound. The hydrocarbon group can be saturated or unsaturated, e.g., containing olefinic unsaturation, and can be unsubstituted or substituted with such groups as halogen, e.g., 1 to 3 halogens such as chlorine and fluorine, alkoxy groups, e.g., methoxy or ethoxy, or nitro groups.

The term “alkyl” means a straight or branched chain saturated hydrocarbon radical derived from a straight or branched chain hydrocarbon by the removal of one hydrogen atom. In a non-limiting embodiment, the alkyl radical can have from 1-18 carbon atoms or from one to the number of carbon atoms designated. For example, a C₁-C₆ alkyl is an alkyl group having from 1 to 6 carbon atoms, including, but not limited to, methyl, ethyl, i-propyl, n-propyl, n-butyl, isobutyl, tertiary butyl, n-pentyl, n-hexyl and the like.

The terms “lower alkyl” and “lower alkoxy” mean an alkyl or alkoxy radical having from 1 to 6, e.g., 1 to 4, carbon atoms.

The term “aromatic” means pertaining to a compound of carbon and hydrogen that contains in its molecular structure the characteristic closed (cyclic) ring of six carbon atoms, e.g., benzene and naphthalene. The aromatic group can be unsubstituted or substituted with such groups as alkyl groups and haloalkyl groups, e.g., 1 to 3 lower alkyl or haloalkyl groups, such as methyl, ethyl, propyl, etc., and chloroalkyl, such as chloromethyl; halogen, e.g., 1 to 3 halogens such as chlorine, bromine and fluorine; alkoxy groups, such as lower alkoxy groups, e.g., methoxy or ethoxy; or nitro groups.

The term “aryl” means an organic radical derived from an aromatic compound by the removal of one hydrogen atom from the aromatic ring. In a non-limiting embodiment, the aryl radical is an aromatic carbocyclic radical having a single ring, e.g., phenyl, or two condensed rings, e.g., naphthyl. The aryl radical can be unsubstituted or substituted, as described with reference to the aforedescribed “aromatic” group.

The term “amino-protecting group” means a protecting group that preserves an amino group or an amino acid that otherwise would be modified by the chemical reaction in which the amino acid is involved. Non-limiting examples of such protecting groups include the formyl group or lower alkanoyl group having from 2 to 4 carbon atoms, e.g., the acetyl or propionyl group; the trityl or substituted trityl groups, e.g., the monomethoxytrityl and dimethoxytrityl groups, such as 4,4′-dimethoxytrityl; the trichloroacetyl group; the trifluoroacetyl group; the silyl group; the phthalyl group; the (9-fluorenylmethoxycarbonyl) or “FMOC” group; the alkoxycarbonyl group, e.g., tertiary butoxy carbonyl (BOC); or other protecting groups derived from halocarbonates, such as, C₆-C₁₂ aryl lower alkyl carbonates. In the preparation of nucleoside esters, a protecting group that can be removed under mild conditions without hydrolyzing the ester group is typically used. Non-limiting examples chosen from the aforementioned groups of such protecting groups are benzyloxy carbonyl, 9-fluorenylmethoxycarbonyl and t-butoxy carbonyl. Such amino-protecting groups can be removed by conventional procedures, such as by catalytic hydrogenation or by the use of an acid or base.

The term “protected amino acid” means an amino acid in which the amino group is protected by an amino-protecting group and is thus protected from taking part in chemical reactions that can occur during the esterification reaction.

The term “derived” or “derivative” of a compound means a compound obtainable from the original compound by a chemical process.

The term “halogen” or “halo” means fluorine (fluoro), chlorine (chloro), bromine (bromo) or iodine (iodo).

The term “nucleoside analogue” means a purine or pyrimidine base having a side chain that contains a hydroxyl group. Nucleoside analogues used in the method of the present invention have a reactive hydroxyl group in its structure that can couple, e.g., condense, with the carboxyl group of the amino acid under the conditions described herein for preparing the nucleoside analogue ester. Non-limiting examples of nucleoside analogues include, acyclovir and ganciclovir.

The term “optional” or “optionally” means that a described event or circumstance may or may not occur. For example, “optionally substituted phenyl” means that the phenyl radical may or may not be substituted and that the description includes both unsubstituted phenyl and phenyl wherein there is substitution on the aromatic phenyl ring.

The term “protecting group” means a chemical group that (a) preserves a reactive group from participating in an undesirable chemical reaction; and (b) can be removed after protection of the reactive group is no longer required. Removal of the protecting group can be performed by art-recognized methods such as hydrogenation.

In a non-limiting embodiment of the present invention, the protecting group employed is stable under the reaction conditions employed during the esterification reaction, and is removable under the conditions in which the ester bond is stable and under which racemization of the amino acid component of the ester does not occur.

The term “pharmaceutically acceptable” means that which can be used to prepare a pharmaceutical composition that is generally safe and non-toxic and includes that which is acceptable for veterinary use as well as human pharmaceutical use.

The term “pharmaceutically acceptable salt” means a salt that possess the desired pharmacological activity and which is neither biologically nor otherwise undesirable. Such salts include, but are not limited to, acid addition salts formed with inorganic acids, such as hydrochloric acid, sulfuric acid, nitric acid, phosphoric acid, and the like; or with organic acids such as acetic acid, propionic acid, glycolic acid, lactic acid, citric acid, stearic acid and the like.

The term “trityl” means the triphenylmethyl radical (Ph)₃C—.

In non-limiting embodiments of the present invention, the organo phosphoryl halide and organo phosphinic halide activating agents can be represented by the following general formulae:
(R)₂—P(O)—X and (RO)₂—P(O)—X
wherein X is halogen and each R is chosen from C₁-C₁₈ alkyl, C₂-C₄ alkoxy and (R′)ₙPh, wherein each R′ is C₁-C₁₈ alkyl, n is a cardinal number of from 0 to 3 and Ph is phenyl. In alternate embodiments, X is chlorine or bromine, each R is chosen from C₁-C₆ alkyl, C₂-C₃ alkoxy or (R′)ₙPh, wherein each R′ is C₁-C₆ alkyl and n is a cardinal number of from 0 to 2. In a further alternate embodiment, X is chlorine, each R is chosen from C₁-C₄ alkyl, C₂-C₃ alkoxy or (R′)ₙPh, wherein R′ is C₁-C₄ alkyl and n is a cardinal number of from 0 to 1.

Non-limiting examples of organo phosphoryl halide and organo phosphinic halide activating agents include dimethyl chlorophosphate, diethyl chlorophosphate, diethyl bromophosphate, diphenyl chlorophosphate, dimethyl phosphinic chloride, diethyl phosphinic chloride and diphenyl phosphinic chloride.

In a non-limiting embodiment of the present invention, sulfonyl halide activating group can be represented by the general formula:
M-S(O)₂—X,
wherein M is an unsubstituted or substituted aliphatic or aromatic group, and X is halogen, e.g., chlorine or bromine.

Aliphatic sulfonyl halides can be represented by the general formula: Ra—S(O)₂—X,

wherein Ra is an alkyl radical, e.g., C₁-C₁₈ alkyl, such as C₁-C₁₂ alkyl or lower alkyl, a halo C₁-C₁₈ alkyl radical, e.g., trifluoroalkyl such as trifluoromethyl, a C₁-C₄ alkoxy C₁-C₁₈ alkyl radical, e.g., methoxyalkyl, ethoxyalkyl or isopropoxyalkyl, e.g., methoxymethyl, ethoxymethyl or isopropoxyethyl, or a nitro C₁-C₁₈ alkyl radical, e.g., nitromethyl and X is halogen, e.g., chlorine or bromine. Non-limiting examples of aliphatic sulfonyl halides include: methanesulfonyl chloride, ethanesulfonyl chloride and propanesulfonyl chloride.

In a further non-limiting embodiment of the present invention, the aromatic sulfonyl halide activating agent can be represented by the following general formula:
Ar—S(O)₂—X,
wherein X is halogen and Ar is an unsubstituted or substituted aromatic moiety, e.g., an aryl group. In one embodiment, X is chlorine or bromine, and Ar is represented by the general formula (R′)ₙPh, wherein Ph is phenyl, n is a cardinal number of from 0 to 3 and each R′ is C₁-C₁₈ alkyl. In alternate embodiments, X is chlorine or bromine, each R′ is C₁-C₆ alkyl and n is a cardinal number of from 0 to 2. In further alternate embodiments, X is chlorine, each R′ is C₁-C₄ alkyl and n is a cardinal number of from 0 to 1.

Non-limiting examples of such aromatic sulfonyl halides include: benzene-sulfonyl chloride, p-toluenesulfonyl chloride and isopropylbenzene sulfonyl chloride.

The amount of activating agent used in the process described herein is an activating amount; namely, that amount which activates the condensation of the nucleoside analogue and the amino acid. In a non-limiting embodiment of the present invention, the amount of activating agent, e.g., the organo phosphoryl halide or aliphatic or aromatic sulfonyl halide, used can range from 1 to 5, e.g., 1 to 3, equivalents, based on the amount of nucleoside analogue, e.g., acyclovir, used. In alternative embodiments, the amount of activating agent used can range from 0.8 to 1.8 equivalents, based on the amount of nucleoside analogue used.

In a non-limiting embodiment of the present invention, the process of the present invention is performed also in the presence of a tertiary amine. Non-limiting examples of tertiary amines that can be used include 4-(dimethylamino) pyridine, trimethyl amine, triethyl amine, triisopropyl amine, diisopropyl ethyl amine, 1-methyl imidazole, 1,2-dimethyl imidazole, pyridine, collidine, 2,3,5,6-tetramethyl pyridine, 2,6-di-tertiarybutyl-4-dimethylamino pyridine, N-methyl morpholine and mixtures of such tertiary amines.

The amount of tertiary amine used in the process of the present invention can vary. In a non-limiting embodiment, from 1 to 6 equivalents of the tertiary amine, based on the amount of activating agent, is used. In alternative embodiments, from 1 to 4, e.g., 1, 2, 3 or 4 equivalents of tertiary amine, based on the amount of activating agent, is used.

In a non-limiting embodiment of the present invention, the process is performed optionally in the presence of an organic solvent, e.g., a polar aprotic solvent. A polar aprotic solvent is an organic solvent that does not contain a reactive hydrogen atom, such as found in water, an alcohol or a carboxylic acid. Non-limiting examples of organic solvents that can be used in the process of the present invention include diethyl ether, dimethylformamide, 1-methyl-2-pyrrolidinone, acetonitrile, methylene chloride, tetrahydrofuran, 1,3-dimethyl-3,4,5,6-tetrahydro-2(1H)-pyrimidinone, 1,3-dimethyl-2-imidazolidinone, N, N-dimethyl acetamide and the like, and mixtures of such organic solvents.

The amount of organic solvent that can be used in the process of the invention can vary widely. The amount used depends primarily on the practical and economic aspects associated with the use of a particular solvent. Use of too large an amount of solvent impact on the economics of the process due to the need to handle, recover and potentially dispose of large quantities of the solvent; while use of too small an amount of solvent will affect the dispersibility and mixing of the reactants. Typically, that amount of solvent that allows the reactants to be well mixed in the reactor is used. Non-limiting examples of the amount of solvent that can be used include from 1 to 100 mL of solvent, e.g., from 5 to 50 mL of solvent, per gram of nucleoside analogue used in the coupling reaction.

In a non-limiting embodiment of the present invention, the protected amino acid used in the esterification is derived from, for example, amino acids chosen from glycine, L-valine, alanine, leucine, isoleucine, tertiary leucine, norvaline, phenylalanine and methionine. As an alternative to the use of the amino acid, a functional equivalent of the amino acid can be used, e.g., an anhydride of the amino acid.

In a non-limiting embodiment of the present invention, the protected amino acid is used in amounts of from 0.9 to 2 molar equivalents, based on the molar amount of the nucleoside analogue that is used. In alternative embodiments, the protected amino acid is used in amounts of from 1 to 1.5 molar equivalents, based on the molar amount of the nucleoside analogue that is used.

In a non-limiting embodiment of the present invention, the esterification reaction is performed at temperatures ranging between −50° C. and 100° C. In alternate embodiments, the reaction is performed at temperatures between −5° C. and 50° C., e.g., between 0° C. and 30° C. The esterification reaction is typically performed at ambient pressure.

The completeness of the esterification reaction can be followed by HPLC analysis. If such analysis shows that the reaction is incomplete, e.g., a small but significant portion, such as 1% or more, of the nucleoside analogue reactant remains unreacted, additional activating agent and/or tertiary amine can be added to the reaction mixture and the reaction mixture stirred for an additional time period at the chosen reaction temperature to complete the esterification reaction, as evidenced by the amount of remaining nucleoside analogue, e.g., by HPLC analysis.

The esterification reaction can be performed by bringing the reactants, activating agent, tertiary amine and organic solvent (if used) together at the reaction conditions chosen in any appropriate reaction vessel. Stirring of the reaction mixture, e.g., by a mechanical or magnetic stirrer, can assist the kinetics of the reaction. An inert atmosphere, e.g., nitrogen, can be used within the reactor to exclude moisture that can react with the activating agent.

The order in which the reactants, activating agent, tertiary amine and solvent, if used, are added to the reaction vessel can vary. For example, in one non-limiting embodiment, tertiary amine (either all or a partial amount of the total to be used), nucleoside analogue, protected amino acid and optional organic solvent are charged to the reaction vessel, e.g., at ambient temperature and pressure. The mixture is cooled or heated to the chosen reaction temperature and then activating agent is added. If a partial amount of the tertiary amine is charged initially to the reaction vessel, the remainder of the tertiary amine is added at this time. In an alternate non-limiting embodiment, nucleoside analogue, activating agent, organic solvent and protected amino acid are added to the reaction vessel at ambient temperature and pressure. The reaction mixture is cooled to the chosen reaction temperature and then tertiary amine is added to the cooled mixture.

In a further alternate non-limiting embodiment, nucleoside analogue, organic solvent and protected amino acid are charged to the reaction vessel at ambient temperature and pressure. The mixture is cooled or heated to the chosen reaction temperature, and then tertiary amine and activating agent are added separately, e.g., tertiary amine and then activating agent, or activating agent and then tertiary amine, or substantially simultaneously, to the reaction vessel. In a still further alternate non-limiting embodiment, protected amino acid, tertiary amine, and optional organic solvent are charged to the reaction vessel at ambient temperature and pressure. This mixture is cooled to the chosen reaction temperature and then activating agent and nucleoside analogue are added separately, e.g., substantially simultaneously, to the mixture.

The amino acid ester of the nucleoside analogue (“the ester”) is recovered from the reaction mixture by methods well known to those skilled in the art. For example, in a non-limiting embodiment, the reaction mixture is mixed with water or a mixture of water and a lower alkanol, such as ethanol or isopropanol, followed by isolating the ester from the slurry, e.g., by conventional liquid-solid separating methods, such as filtration (gravity or suction) or centrifugation. The isolated ester can be washed with water and/or a lower alkanol, non-limiting examples of which include methanol and ethanol, and dried at temperatures at which the ester is not adversely affected, e.g., the ester does not decompose. In a non-limiting embodiment, drying can be performed at temperatures from 30° C. to 110° C., such as 40° C., in an oven at ambient pressure. Alternatively, drying can be performed under vacuum, e.g., from 1 to 100 Torr, e.g., 15 to 30 Torr.

An alternate non-limiting method for recovering the ester includes adding water to the reaction mixture, heating to temperatures of, for example from 65° C. to 100° C., optionally filtering the resulting solution to remove undesired by-products, and cooling the solution to precipitate the ester, which can be recovered by conventional liquid-solid separating methods, as described above. Other non-limiting methods for recovering the ester from the reaction mixture are described in the following examples, which are illustrative only. Other equivalent ester separation and recovery procedures can, of course, be used.

Purification of the ester can be effected by known procedures, including, but not limited to, re-crystallization, extraction, column chromatography, thin- or thick-layer chromatography or a combination of such purification methods. After isolation, recovery and/or purification, protecting groups for the amino group present in the ester can be optionally removed by conventional methods known in the art, as described earlier.

Pharmaceutically acceptable addition salts of the ester can be prepared by reacting the ester with a pharmaceutically acceptable acid. Such acids include, but are not limited to, mineral acids such as hydrochloric acid, sulfuric acid, nitric acid and phosphoric acid, and organic acids such as methane sulfonic acid, ethane sulfonic acid, maleic acid, fumaric acid, citric acid, tartaric acid, lactic acid, p-toluene sulfonic acid, acetic acid, propionic acid, glycolic acid, lactic acid, citric acid, stearic acid and the like.

The present invention is more particularly described in the examples that follow, which are intended to be illustrative only, since numerous modifications and variations therein will be apparent to those skilled in the art. Unless otherwise specified, described percentages are by weight. Further, unless otherwise specified, the esterification reaction reported in the Examples is performed at ambient pressure.

In addition, although the following examples exemplify embodiments of the invention by using valine, e.g., L-valine, as the amino acid and acyclovir as the nucleoside analogue, their use is only for purposes of exemplification. It is evident to those skilled in the art from the description that other amino acids and other nucleoside analogues can be substituted in place of the described valine and acyclovir. Moreover, although the esterification reactions described in the following examples illustrate embodiments of the present invention using certain tertiary amines and activating agents, e.g., organo phosphoryl halides, organo phosphinic halides, aliphatic sulfonyl halides and aromatic sulfonyl halides, their use is only for purposes of exemplification. It would be clear to those skilled in the art from the description that other tertiary amines and other structurally similar organo phosphoryl halides activating agents, aliphatic sulfonyl halide activating agents and aromatic sulfonyl halide activating agents can be substituted in place of the specifically described tertiary amines and activating agents.

HPLC analyses for area % Z-Valacyclovir performed in the following examples are performed in the reverse phase mode using the following equipment and conditions: Column—Inertsil C8-3, 5μ, 250×4.6 mm; Column temperature—40° C.; UV Wavelength—254 nm; Flow rate—1.5 mL/minute; Mobile Phase (Eluant)—A=deionized water and 0.02% phosphoric acid, B=acetonitrile.

| Time (min) | % A | % B |
|---|---|---|
| 0 | 80 | 20 |
| 15 | 5 | 95 |
| 25 | 5 | 95 |
| 26 | 80 | 20 |

Other equivalent packing materials and equivalent columns can also be used, as is known by those skilled in the art of HPLC analyses. Further, modifications to the foregoing HPLC method can also be made, as is known to those skilled in the art. Solvent programming or isochratic elution can be used for analyses. Flow rates of 1-2 mL of solvent per minute and detection wavelengths of 200 to 280 nm can be used.

### EXAMPLE 1

To a 250 milliliter (mL) reaction flask equipped with mechanical stirrer and thermometer was charged under nitrogen 13.2 grams of N-benzyloxycarbonyl-L-valine (Z-valine), 40 mL of N,N-dimethylformamide (DMF) and 12.3 grams of N-methyl morpholine. The mixture was cooled to 0° C. and 11.4 grams of benzene sulfonyl chloride was added to the mixture over 15 minutes while maintaining the temperature of the mixture at below 5° C. The mixture was then stirred for 30 minutes. Acyclovir (11.7 grams, containing approximately 5% water) was added to the cooled mixture, which was then stirred for 6 hours while maintaining-the temperature of the mixture at from 0° C. to 5° C. The mixture was then stirred overnight at room temperature.

To the foregoing mixture was added 70 mL of ethanol. No precipitate formed, but the mixture was turbid. The resultant solution was filtered under suction through a 10-15 micron frit. The filtrate was stripped in vacuo (60 Torr) at 50° C. to a weight of 120 grams. 75 mL of water was added to this material whereupon a white precipitate formed. This slurry was heated to 70° C. and the solution obtained was cooled gradually to room temperature over 2 hours. Granular crystals formed at approximately 64-65° C. The crystals were recovered by filtration, washed twice with 100 mL portions of water and twice with 60 mL portions of isopropanol. The crude product was dissolved in 50 mL of DMF and heated to 70° C. Water (100 mL) was added and the thick white precipitate that was obtained was heated to 85-86° C. to dissolve the crystals and then cooled gradually to room temperature. A white granular crystal product was recovered by filtration, washed with water and then isopropanol, and dried in air to obtain 24 grams of product. The above product was dissolved in 50 mL dimethylformamide and heated to 70° C. Water (100 mL) was added and a thick white precipitate was obtained. The precipitate was heated back to 90-95° C., and an additional 10 mL of dimethyl formamide was added to obtain a clear solution. The solution was cooled overnight to room temperature and the product was recovered by filtration. The product was washed with water and isopropanol and then dried in vacuo to obtain 18 grams of product. HPLC analysis showed the product to be 96.8% (area normalized) Z-valacyclovir.

### EXAMPLE 2

To a 250 mL reaction flask, as described in Example 1, was charged under nitrogen 13.8 grams of Z-valine, 11.3 grams of dry acyclovir and 50 mL of DMF. (The acyclovir was dried in a vacuum oven at 80-85° C. and at less than 5 Torr vacuum for 4 hours.) The mixture in the reaction flask was stirred and cooled to approximately 0-2° C. Benzene sulfonyl chloride (12.4 grams) was added all at once to the cooled mixture and the reaction mixture stirred for 10 minutes. 1-methyl imidazole (12.6 grams) was added drop wise to the reaction mixture over a period of 1 hour and the mixture stirred at 0-5° C. for 4 hours, and then overnight at room temperature. HPLC analysis of the reaction mixture indicated that the esterification reaction was incomplete. Additional 2.2 grams of benzene sulfonyl chloride was added drop wise to the reaction mixture with stirring. The reaction mixture was stirred at 18-20° C. for 2.5 hours. HPLC analysis of the reaction mixture indicated that approximately 2% of the acyclovir remained unreacted. An additional 1 gram of benzene sulfonyl chloride was added all at once to the reaction mixture, which was stirred for 1 additional hour.

Water (75 mL) was added to the reaction mixture and the slurry obtained was heated to 80-85° C. whereat a substantial portion of the solids in the reaction mixture dissolved. The solution was cooled gradually to room temperature. The crystals obtained were recovered by filtration and washed twice with approximately 50 mL portions of water. The wet cake was stirred in 60 mL of 95% ethanol and heated to reflux. The mixture in the flask was cooled with stirring overnight to room temperature. The solids that formed were recovered by filtration and washed with 50 mL ethanol and dried in vacuo. The dried product was slurried in a mixture of 50 mL water and 50 mL methanol at 60-65° C., cooled to room temperature, filtered, washed with methanol and dried in vacuo. The product yield was 19.0 grams. HPLC analysis of the recovered product revealed it to be 98.5% Z-valacyclovir (area percent).

### EXAMPLE 3

To a 250 mL reaction flask, as described in Example 1, was charged 11.9 grams of acyclovir containing approximately 5% water, 13.8 grams of Z-valine, 13.8 grams of 1-methyl imidazole and 50 mL of DMF. The mixture was cooled to 10° C. with stirring under nitrogen and 13.4 grams of benzene sulfonyl chloride was added drop wise over 1 hour and 45 minutes while maintaining the temperature of the reaction mixture at 10-15° C. Thereafter, the reaction mixture was stirred for an additional 30 minutes at 10-15° C. and then allowed to warm to room temperature. HPLC analysis did not show the presence of any acyclovir.

Water (40mL) was added to the reaction flask and the contents of the flask heated to 85-90° C. to dissolve the precipitate that had formed. The solution was cooled gradually over approximately 2 hours to ambient (room) temperature. The solids that formed were recovered by filtration, and washed three times with 100 mL portions of water. The product was dried in a vacuum oven at approximately 100° C. and 20-25 Torr. The dried product (20.1 grams) was analyzed by HPLC and found to be greater than 99% Z-valacyclovir.

### EXAMPLE 4

A 250 mL reaction flask, as described in Example 1, was charged with 11.3 grams of dry acyclovir, 13.8 grams of Z-valine, 30 mL of DMF and 13.8 grams of 1-methyl imidazole. The mixture was cooled to temperatures of 10-12° C., and a solution of 14.3 grams of p-toluene sulfonyl chloride in 20 mL of DMF was added drop wise over one hour while the mixture was at a temperature of 10-15° C. The mixture was stirred at 10-15° C. for 2 hours and then overnight at room temperature. Water (50 mL) was then added to the reaction flask and the reaction mixture heated to 90-95° C. The resultant solution was cooled over 4 hours to room temperature and the solid crystalline product that formed was recovered by filtration. The crystals were washed three times with 100 mL portions of water, followed by washing two times with 50 mL portions of ethanol. The washed crystals were dried in a vacuum oven at 95-100° C. and 20-25 Torr. 18.2 grams of solid Z-valine acyclovir product were obtained, which by HPLC analysis was found to be greater than 97% pure.

### EXAMPLE 5

A 100 mL reaction flask equipped with mechanical stirrer and thermometer was charged with 5.65 grams of dry acyclovir, 6.9 grams of Z-valine, 6.9 grams of 1-methyl imidazole and 25 mL of acetonitrile. The mixture was stirred magnetically and cooled with stirring to 10° C. Benzene sulfonyl chloride (6.7 grams) was added drop wise over 15 minutes to the reaction mixture, which was then stirred for 1 hour at 10-15° C., followed by stirring for 2 hours at room temperature. HPLC analysis indicated that the esterification reaction was incomplete. Additional 1-methyl imidazole (0.43 grams) and benzene sulfonyl chloride (0.67 grams) was added to the reaction flask and the contents stirred for 2 hours at room temperature. HPLC analysis of the reaction mixture indicated that the reaction was substantially complete. Water (25 mL) was added to the reaction mixture, which was warmed to approximately 40° C. and stirred at that temperature for 30 minutes. The mixture was cooled to room temperature and the crystals that formed were recovered by filtration. The crystals were washed with water and then with ethanol, and then dried under vacuum (20-25 Torr) to obtain 9.8 grams of product, which by HPLC analysis was 98.5% Z-valacyclovir.

### EXAMPLE 6

A mixture of 11.8 grams of dry acyclovir, 13.8 grams of Z-valine and 50 mL of DMF was cooled in a reaction flask to 5° C. and 13.4 grams of benzene sulfonyl chloride was added to the cooled mixture. Over a period of 1 hour, a mixture of 10.2 grams of N-methyl morpholine and 4.7 grams of 1-methyl imidazole was added to the contents of the reaction flask, while maintaining the contents at 5-10° C. The contents of the reaction flask were stirred for 4 hours at that temperature. HPLC analysis of the reaction mixture showed that 10% of acyclovir remained unreacted. Additional benzene sulfonyl chloride (3.4 grams) and 1-methyl imidazole (5 grams) were added to the reaction flask and the contents stirred overnight at room temperature. Water (50 mL) was added to the reaction mixture and the mixture heated to 90° C. Thereafter, the contents of the reaction flask were cooled to room temperature and crystals that formed were recovered by filtration. The recovered crystals were washed three times with 50 mL portions of water. The wet cake was mixed with 100 mL of 95% ethanol and heated to reflux. The resulting mixture was cooled to room temperature and the crystals that formed were recovered by filtration. The filtered solids were washed twice with 95% ethanol and dried in a vacuum oven at 60-65° C. and 20-25 Torr. 19.5 grams of Z-valacyclovir product were recovered. HPLC analysis of the product showed it to have a purity of 97.3%.

### EXAMPLE 7

A 250 mL reaction flask equipped with a mechanical stirrer and thermometer was charged with 10.6 grams of acyclovir (5.6% water), 13.4 grams of N-benzyloxycarbonyl-L-valine (Z-valine), 0.55 grams of dimethylamino pyridine (DMAP) and 40 mL of DMF. Triethyl amine (22.4 grams) was added to the slurry at room temperature over 25 minutes. The resulting slurry was cooled to 0-5° C. Diethyl chlorophosphate (DECP, 15.3 grams) was added drop wise to the cooled slurry over 25 minutes, while maintaining the slurry at approximately 0-10° C. The reaction mixture was stirred for 2 hours at 5-10° C. and then overnight at room temperature. HPLC analysis showed that approximately 2% of the added-acyclovir remained unreacted. DECP (1.53 grams) was added to the reaction flask at room temperature and the contents stirred for an additional 2.5 hours. Water (100 mL) was then added slowly to the reaction mixture. A white solid precipitated. The resulting white slurry was heated to 100° C. and maintained at that temperature for approximately 20 minutes. The reaction mixture was then cooled to room temperature and stirred overnight. Precipitated solids in the reaction mixture were isolated by filtration and washed once with 40 mL of water and two times with 40 mL of methanol. The washed solids were dried over 4 hours in a vacuum oven at 65° C. and 20 Torr. 20.9 grams of product were recovered, which HPLC analysis showed to be 99% pure Z-valacyclovir by area percent.

### EXAMPLE 8

A 250 mL reaction flask equipped with a mechanical stirrer and thermometer was charged with 10.6 grams of acyclovir (5.6% water), 13.4 grams of Z-valine and 40 mL of DMF. 1-methyl imidazole (18.6 grams) was added to the reaction flask at room temperature over 10 minutes. The resulting slurry was cooled to 0-5° C. and diethyl chlorophosphate (15.3 grams) was added drop wise to the slurry over 30 minutes while maintaining the slurry at 0-10° C. The reaction mixture was stirred for 5 hours at 10° C. and then overnight at room temperature. Water (100 mL) was added to the reaction mixture and the resulting white slurry was heated to approximately 100° C. The resulting solution was cooled to room temperature and the solids that formed were isolated by filtration. Recovered solids were washed with water (40 mL) and twice with 40 mL portions of methanol. The washed solids were vacuum dried at 65° C. and 25 Torr for 6 hours. The dried product (20.2 grams) was analyzed by HPLC and found to be 99.4% Z-valacyclovir by area percent).

### EXAMPLE 9

A 250 mL reaction flask equipped with a mechanical stirrer and thermometer was charged with 10.6 grams of acyclovir (5.6% water), 12.3 grams of Z-valine, 0.55 grams of N,N-dimethylamino pyridine (DMAP) and 40 mL of DMF. Triethylamine (15.7 grams) was added to the contents of the reaction flask at room temperature and over 6 minutes. The resultant slurry was cooled to 3° C., and 11.5 grams of diethyl chlorophosphate (DECP) added drop wise to the cooled slurry over 1-hour while maintaining the slurry at 0-10° C. The reaction mixture was stirred for 3 hours at 5-10° C. and then overnight at room temperature. Additional DECP (1.5 grams) was added to the reaction mixture at room temperature, which was then stirred for 22 hours at room temperature. Water (100 mL) was added to the reaction mixture and the resulting white slurry heated to 97° C. and kept at that temperature for 5 minutes. The reaction mixture was then cooled to room temperature and solids in the mixture isolated by filtration. The recovered solids were washed once with water (40 mL) and then twice with 40 mL portions of methanol. The washed white solids were vacuum dried at 65° C. and 25 Torr for 6 hours. 18.2 grams of dried product were recovered. HPLC analysis of the dried product showed it to be 99.2% pure Z-valacyclovir by area percent.

### EXAMPLE 10

A 250 mL reaction flask was charged with 10.6 grams of acyclovir (5.6% water), 12.3 grams of Z-valine, 0.55 grams of DMAP and 40 mL of DMF. N-methyl morpholine (NMM, 15.7 grams) was added to the reactions flask at room temperature over 10 minutes. The resulting slurry was cooled to 2° C., and diethyl chlorophosphate (DECP, 11.5 grams) was added drop wise to the cooled slurry over 15 minutes while maintaining the slurry at 1-10° C. The reaction mixture was stirred for 3 hours at 3° C., and then overnight at room temperature. Additional DECP (3.83 grams) was added to the reaction mixture at room temperature. The reaction mixture was then stirred for 6 hours followed by the addition of 4.5 grams of NMM at room temperature. After 17 hours additional stirring, more DECP (1.5 grams) was added at room temperature. The reaction mixture was then stirred for 4.25 hours at room temperature, and thereafter 100 mL of water was added to the mixture. The resulting white slurry was heated to 95° C. and kept at that temperature for 15 minutes. The resulting solution was cooled to room temperature and solids that formed were isolated by filtration. The recovered solids were washed once with water (40 mL) and twice with 40 mL of methanol. The washed white solids were vacuum dried at 65° C. and 25 Torr. HPLC analysis of the product (19.6 grams) showed it to be 98% pure Z-valacyclovir by area percent.

### EXAMPLE 11

A 250 mL reaction flask was charged with 10.6 grams of acyclovir (5.6% water), 12.3 grams of Z-valine, 0.55 grams-of DMAP and 40 mL of DMF. N,N-diisopropyl ethylamine (20.1 grams) was added to the-reaction flask at room temperature over 8 minutes. The resulting slurry was cooled to 3° C. and 13.1 grams of DECP added drop wise to the cooled slurry over 23 minutes while maintaining the slurry within the range of 3-7° C. The reaction mixture was stirred for 1.75 hours at 4-5° C. and then for 4 days at room temperature. Water (80 mL) was added to the reaction mixture and the resulting white slurry heated to 100° C. and maintained at that temperature for 20 minutes. The resulting solution was cooled to room temperature, and solids that formed were isolated by filtration. The recovered solids were washed once with water (40 mL) and twice with 40 mL portions of 95% ethanol. The washed white solid was vacuum dried at 65° C. and 25 Torr for 6 hours. The dried solid product (22.0 grams) was analyzed by HPLC and found to be 98.2% pure Z-valacyclovir by area percent.

### EXAMPLE 12

A 500 mL automated reactor flask equipped with a thermocouple, agitator, nitrogen inlet, bubbler and addition lines was charged with 150 mL DMF, 34.8 grams of acyclovir (4.4% water) and 41.4 grams of Z-valine. The slurry in the reactor was cooled to 10° C. and the addition of 44.3 grams of 1-methyl imidazole (NMI) to the reactor at a rate of 0.738 g/min was begun. After 3 minutes, the addition of 47.6 grams of benzene sulfonyl chloride (BSC) was begun at a rate of 1.06 g/min. The total addition time for NMI was 60 minutes, and the total addition time for BSC was 45 minutes. The temperature within the reactor was maintained at 10° C. during the addition of the NMI and BSC. Progress of the reaction was monitored by HPLC. After 5.5 hours, 150 mL of water was added all at once to the yellow homogeneous reaction mixture, which resulted in the formation of a slurry of white granules. The slurry was heated to 85° C., held at that temperature for 10 minutes, and then cooled to room temperature (about 20° C.) at a rate of 1.0° C./minute. The resulting crude reaction slurry was stirred overnight at room temperature.

The crude reaction slurry was filtered and the crystals recovered were washed two times with 150 mL of water. The wet cake was charged to a 500 mL 3-necked flask equipped with agitator, nitrogen inlet/bubbler and thermocouple. Water (150 mL) was added to the flask and the resultant slurry heated to 80° C. for one hour. The slurry was allowed to cool to room temperature, and the crystals in the slurry filtered. The filter cake was washed two times with 150 mL of water and one time with 150 mL of 95% ethanol. The washed filter cake was allowed to dry in air for approximately 2 hours, and was returned to the 3-necked flask. Isopropanol (300 mL) was added to the flask, and the resultant slurry heated to 74° C. for 0.5 hours before allowing it to cool to room temperature. The crystals were filtered and washed two times with 150 mL of isopropanol. The wet cake product was dried at 70-75° C. at 20-25 Torr for 3 hours to obtain a yield of 58.15 grams. HPLC analyses showed the product to be 98.2% (area percent normalized) Z-valacyclovir.

### EXAMPLE 13

A 250 mL reaction flask equipped with mechanical stirrer and thermometer was charged with 10.5 grams of acyclovir (5.6% water), 13.4 grams of Z-valine, and 40 mL of DMF. The resulting slurry was cooled to 3° C. and 6.2 grams of N-methyl imidazole (NMI) was added drop wise to the cooled slurry over 5 minutes while maintaining the slurry at 3° C. The reaction mixture was cooled to −2° C., followed by the addition of 8.65 grams of methane sulfonyl chloride (MSC) over approximately 1.5 hours, while maintaining the temperature of the reaction mixture at 0-1° C. Additional NMI (6.2 grams) was then added to the reaction mixture over 1.5 hours at 1-5° C. The reaction mixture was stirred for 1 hour 50 minutes, and an additional 1.1 grams of NMI was added to the mixture at 5° C. The reaction mixture was stirred for 1 hour 35 minutes at 4-7° C., and 0.36 grams of additional NMI was added to the mixture. The reaction mixture was stirred for 16 hours and 35 minutes in an ice-bath (1-5° C.). Water (40 mL) was added to the reaction mixture and the resulting slurry was then heated to 103° C., thereby to form a light yellow solution. A white solid was observed in the solution after it was cooled to room temperature. The solid was recovered by filtration and washed once with water (50 mL) and two times with 50 mL of a water/ethanol mixture (1:1, v/v). The wet cake was placed in a 250 mL flask containing 100 mL of a water/ethanol mixture (15/85, v/v). The resulting slurry was heated to 79° C. and kept at that temperature for 5 minutes. The resulting solution was cooled to 30° C. The solids that formed upon cooling were recovered by filtration and washed two times with 50 mL of an ethanol/water mixture (3/1, v/v). The white solid was air-dried overnight and then vacuum dried at 65° C. and 25 Torr for 6 hours. The dried solid product (17.8 grams) was analyzed by HPLC and found to be 97.2% pure Z-valacyclovir by area percent.

The present invention has-been described with reference to specific details of particular embodiments thereof. It is not intended that such details be regarded as limitations upon the scope of the invention except insofar as and to the extent that they are included in the accompanying claims.

What is claimed is:

1. A process for preparing esters of nucleoside analogues comprising condensing a nucleoside analogue with a protected amino acid in the presence of a tertiary amine and an activating amount of an activating agent chosen from an organophosphoryl halide, organo phosphonic halide, aliphatic sulfonyl halide and aromatic sulfonyl halide.

2. The process of claim 1 wherein the organo phosphoryl halide and organo phosphinic halide activating agents can be represented by the general formulae,
(R)₂—P(O)—X (RO)₂—P(O)—X
wherein X is halogen and each R is chosen from C₁-C₁₈ alkyl, C₂-C₄ alkoxy or (R′)ₙPh, and wherein Ph is phenyl, n is a cardinal number of from 0 to 3 and each R′ is a C₁-C₁₈ alkyl.

3. The process of claim 2 wherein X is chlorine or bromine, each R is chosen from C₁-C₆ alkyl, C₂-C₃ alkoxy or (R′)ₙPh, wherein, n is a cardinal number of from 0 to 2, and each R′ is a C₁-C₆ alkyl.

4. The process of claim 3 wherein the organo phosphoryl halide and organo phosphinic halide are chosen from dimethyl chlorophosphate, diethyl chlorophosphate, diethyl bromophosphate, diphenyl chlorophosphate, dimethyl phosphinic chloride, diethyl phosphinic chloride and diphenyl phosphinic chloride.

5. The process of claim 1 wherein the sulfonyl halide activating agent can be represented by the general formula,
M-S(O)₂—X,
wherein X is halogen and M is chosen from an aliphatic or aromatic group.

6. The process of claim 5 wherein:
(a) the aromatic sulfonyl halide activating agent is represented by the general formula:
Ar—S(O)₂—X,
wherein X is chlorine or bromine, and Ar is an aromatic moiety represented by the general formula (R′)ₙ, wherein Ph is phenyl, n is a cardinal number of from 0 to 3, and each R′ is a C₁-C₁₈ alkyl, and
(b) the aliphatic sulfonyl halide activating agent is represented by the general formula,
Ra—S(O)₂—X,
wherein Ra is chosen from a C₁-C₁₈ alkyl radical, a halo C₁-C₁₈ alkyl radical, a C₁-C₄ alkoxy C₁-C₁₈ alkyl radical, or a nitro C₁-C₁₈ alkyl radical, and X is chlorine or bromine.

7. The process of claim 6 wherein the aromatic sulfonyl halide is chosen from benzenesulfonyl chloride, p-toluenesulfonyl chloride and isopropylbenzene sulfonyl chloride, and the aliphatic sulfonyl chloride is chosen from methanesulfonyl chloride, ethanesulfonyl chloride and propanesulfonyl chloride.

8. The process of claim 1 wherein the nucleoside analogue is selected from acyclovir or ganciclovir.

9. The process of claim 1 wherein the amino-protected amino acid is derived from amino acids chosen from glycine, valine, alanine, leucine, isoleucine, tertiary leucine, norvaline, phenylalanine, and methionine.

10. The process of claim 1 wherein the amino acid is L-valine and the protecting group is chosen from benzyloxycarbonyl, t-butoxy carbonyl and 9-fluorenylmethoxycarbonyl.

11. The process of claim 1 wherein from 0.9 to 2 molar equivalents of the protected amino acid per molar equivalent of the nucleoside analogue is used.

12. The process of claim 1 wherein the tertiary amine is chosen from 4-(dimethylamino) pyridine, trimethyl amine, triethyl amine, triisopropyl amine, diisopropyl ethyl amine, 1-methyl imidazole, 1,2-dimethyl imidazole, pyridine, collidine, 2,3,5,6-tetramethyl pyridine, 2,6-di-tertiary-butyl-4-dimethylamino pyridine, N-methyl morpholine and mixtures of such tertiary amines.

13. The process of claim 1 wherein the tertiary amine is present in amounts of from 1 to 6 equivalents, based on the amount of activating agent.

14. The process of claim 1 wherein the condensation is performed at temperatures between −50° C. and 100° C.

15. The process of claim 1 wherein the condensation is performed in the presence of an organic solvent.

16. The process of claim 14 wherein the solvent is a polar aprotic solvent.

17. The process of claim 16 wherein the polar aprotic solvent is chosen from diethyl ether, dimethylformamide, 1-methyl-2-pyrrolidinone, acetonitrile, methylene chloride, tetrahydrofuran, 1,3-dimethyl-3,4,5,6-tetrahydro-2-( 1 H)-pyrimidinone, 1,3-dimethyl-2-imidazolidinone, N,N, dimethyl acetamide and mixtures of such solvents.

18. The process of claim 1 wherein the activating agent is added to a mixture of the nucleoside analogue, protected amino acid and tertiary amine, said mixture being at the chosen condensation temperature.

19. The process of claim 1 wherein the activating agent and tertiary amine are added to a mixture of the nucleoside analogue and the protected amino acid, said mixture being at the chosen condensation temperature.

20. The process of claim 1 wherein the activating agent and tertiary amine are added to a mixture of the protected amino acid and nucleoside analogue, said mixture being at the chosen condensation temperature.

21. A process for preparing Z-valine acyclovir, comprising condensing acyclovir with benzyloxy carbonyl protected L-valine in the presence of a tertiary amine chosen from 4-(dimethylamino) pyridine, trimethyl amine, triethyl amine, triisopropyl amine, diisopropyl ethyl amine, 1-methyl imidazole, 1,2-dimethyl imidazole, pyridine, collidine, 2,3,5,6-tetramethyl pyridine, 2,6-di-tertiary-butyl-4-dimethylamino pyridine, N-methyl morpholine and mixtures of such tertiary amines, and an activating amount of an activating agent chosen from dimethyl chlorophosphate, diethyl chlorophosphate, diethyl bromophosphate, diphenyl chlorophosphate, dimethyl phosphinic chloride, diethyl phosphinic chloride, diphenyl phosphinic chloride, benzenesulfonyl chloride, p-toluenesulfonyl chloride, isopropylbenzene sulfonyl chloride, methanesulfonyl chloride, ethanesulfonyl chloride and propanesulfonyl chloride, said condensation being performed at temperatures from −5° C. to 50° C.

22. The process of claim 21 wherein the condensation is performed in the presence of a polar aprotic solvent chosen from diethyl ether, dimethylformamide, 1-methyl-2-pyrrolidinone, acetonitrile, methylene chloride, tetrahydrofuran, 1,3-dimethyl-3,4,5,6-tetrahydro-2-(1H)-pyrimidinone, 1,3-dimethyl-2-imidazolidinone, N,N, dimethyl acetamide and mixtures of such solvents.
